(19) United States
(12) Patent Application Publication
(10) Pub. No.: US 2006/0241195 A1
(43) Pub. Date: Oct. 26, 2006

(54) Compositions based on expandable vinylaromatic polymers with an improved expandability

(75) Inventors: Alessandro Casalini, Mantova (IT); Aldo Longo, Mantova (IT); Dario Ghidoni, Gonzaga-Mantova (IT); Roberto Lanfredi, Virgilio-Montova (IT)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: POLIMERI EUROPA S.p.A., Brindisi (IT)

(21) Appl. No.: 11/454,936

(22) Filed: Jun. 19, 2006

Related U.S. Application Data
(62) Division of application No. 10/507,939, filed on May 13, 2005, now abandoned.

(30) Foreign Application Priority Data
Mar. 20, 2002 (IT) MI2002A000584

(51) Int. Cl. C08J 9/00

(52) U.S. Cl. 521/79

(57) ABSTRACT

Compositions of expandable vinylaromatic polymers which contain a polymer, of at least one vinylaromatic monomer, having an average molecular weight Mw ranging from 50,000 to 170,000, which comprise: a) 0-50% by weight of a copolymer obtained by polymerizing one or more vinylaromatic monomers and 0.1-15% by weight of an α-alkylstyrene; b) 0-10% by weight of a compatible polymer having a crystallinity lower than 10% and a glass transition temperature (Tg) higher than 100° C., the remaining percentage consisting of the vinylaromatic polymer; c) 2-10% by weight, calculated with respect to the total, of an expanding agent; with the proviso that at least one of (a) or (b) is present in the polymeric mixture.

The present invention relates to compositions based on vinylaromatic polymers with an improved expandability.

More specifically, the present invention relates to compositions based on polystyrene, with an improved expandability.

Vinylaromatic polymers, and among these, polystyrene in particular, are known products which have been adopted for a long time for preparing compact and/or expanded articles which can be used in various applicative sectors, among which the most important are household appliances, the transport and building industries, office machines, etc. A, particularly interesting sector is the field of thermal insulation, where vinylaromatic polymers are essentially used in expanded form.

These expanded products are obtained by pre-foaming in a pre-expander beads of expandable polymer previously impregnated with an expanding agent and molding the pre-foamed particles contained inside a closed mould by means of the contemporaneous effect of pressure and temperature. The foaming of the particles is generally effected with vapour, or another gas, maintained at a temperature slightly higher than the glass transition temperature (Tg) of the polymer.

It is known that the expandability of vinylaromatic polymers, referring to the possibility of obtaining low density products without their collapsing, can be improved by means of suitable additives.

According to European patent 217,516, for example, the expandability of vinylaromatic polymers can be improved by adding plasticizers such as rubbers or oils, to the polymer. Additives contained in resins effectively cause a good, immediate expansion but, as they remain englobed in the polymeric matrix, they cause the products to collapse with a consequent deterioration in the density.

The use of oligomers of aliphatic olefins, as described in U.S. Pat. No. 5,783,612, also improves, for example, the expandability of polystyrene but reduces the processability range.

It has been verified that the reduction of the molecular weight of polymers to values lower than 50,000 also implies an excellent expandability but with the detriment of the processability and mechanical characteristics of the end-product.

Object of the present invention is to provide an expandable composition based on vinylaromatic polymers with an improved expandability which can be processed with technologies and operating conditions analogous to those of equivalent products available on the market.

The Applicant has now found that this and other objects, which will appear evident from the following description, can be obtained through certain expandable polymeric mixtures containing a polymer of at least one vinylaromatic monomer having an average molecular weight Mw ranging from 50,000 to 170,000, which comprise:
a) 0-50% by weight of a copolymer obtained by polymerizing one or more vinylaromatic monomers and 0.1-15% by weight of an α-alkylstyrene;
b) 0-10% by weight of a compatible polymer having a crystallinity lower than 10 and a glass transition temperature (Tg) higher than 100° C., the remaining percentage consisting of the vinylaromatic polymer;
c) 2-10% by weight, calculated with respect to the total, of an expanding agent;
   with the proviso that at least one of (a) or (b) is present in the polymeric mixture.

The term “vinylaromatic monomer”, as used in the present description and claims, essentially refers to a product which corresponds to the following general formula: 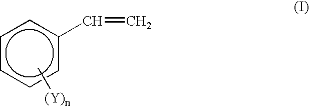
wherein n is zero or an integer ranging from 1 to 5 and Y is a halogen, such as chlorine or bromine, or an alkyl or alkoxyl radical having from 1 to 4 carbon atoms.

Examples of vinylaromatic monomers having the general formula defined above are: styrene, methylstyrene, ethylstyrene, butylstyrene, dimethylstyrene, mono-, di-, tri-, tetra- and penta-chlorostyrene, bromo-styrene, methoxy-styrene, acetoxy-styrene, etc. Styrene is the preferred vinylaromatic monomer.

The vinylaromatic monomers having general formula (I) can be used alone or in a mixture of up to 50% by weight with other copolymerizable monomers. Examples of these monomers are (meth)acrylic acid; C₁-C₄ alyl esters of (meth)acrylic acid, such as methyl acrylate, methyl-methacrylate, ethyl acrylate, ethylmethacrylate, isopropyl acrylate, butyl acrylate; amides and nitrites of (meth)acrylic acid such as acrylamide, methacrylamide, acrylonitrile, methacrylonitrile; butadiene, ethylene, divinylbenzene, maleic anhydride, etc. Preferred copolymerizable monomers are acrylonitrile and methylmethacrylate.

The vinylaromatic polymer or copolymer which is obtained has a molecular weight Mw ranging from 50,000 to 170,000, preferably from 70,000 to 150,000.

The vinylaromatic monomers are also copolymerized with an α-alkylstyrene in quantities ranging from 0.1 to 15% by weight, preferably from 2 to 10%, to give the copolymer (a). The preferred α-alkylstyrene according to the present invention is α-methylstyrene, α-ethylstyrene or α-propylstyrene. α-methylstyrene is particularly preferred.

Any expanding agent capable of being englobed in the polymeric matrix can be used in a combination with the vinylaromatic polymers object of the present invention. In general, liquid substances can be used, with a boiling point ranging from 10 to 100° C., preferably from 20 to 80° C. Typical examples are aliphatic hydrocarbons, freon, carbon dioxide, water, etc.

The expanding agent (c) can be added to the polymeric mixture during the polymerization phase, as described below, or, alternatively, by impregnation of the beads produced at the end of the polymerization or by injection into the molten product. At the end of the addition, a polymer is obtained, which can be transformed to produce expanded articles with a density ranging from 5 to 50 g/l, preferably from 8 to 25 g/l, with an excellent thermal insulation capacity. In order to favour the retention of the expanding agent in the polymeric matrix, additives capable of forming bonds both of the weak type (for example hydrogen bridges) or strong type (for example acid-base adducts) can be used with the expanding agent. Examples of these additives are methyl alcohol, isopropyl alcohol, dioctylphthalate, dimethylcarbonate, derivatives containing an amine group.

The compatible polymer (b) with a crystallinity degree lower than 10%, preferably equal to or lower than 5%, and a Tg higher than 100° C., is preferably used in quantities ranging from 2 to 8% by weight. Examples of these polymers are polyphenylethers, such as polyphenyleneoxide (PPO) and polycarbonates such as polycarbonate from tetramethyl-bisphenol A.

Conventional additives, generally used with commercial materials, such as pigments, stabilizers, flame-retardant agents, mineral fillers of athermanous materials, such as graphite or carbon black, or refracting and/or reflecting agents such as titanium dioxide, antistatic agents, detaching agents, shock-resistant agents, etc., can be added to the expandable vinylaromatic polymers, object of the present invention.

Vinylaromatic polymers with an improved expandability can alternatively comprise those consisting of:
d) a matrix obtained by polymerizing one or more vinylaromatic monomers and 0.1-14.5% by weight of an α-alkylstyrene;
e) 2-10% by weight, calculated with respect to the polymer (a), of an expanding agent englobed in the polymeric matrix;
f) 0-10% by weight, preferably 2-8% calculated with respect to the polymer (a), of a compatible polymer with a crystallinity lower than 10% and a glass transition temperature (Tg) higher than 100° C.

A further object of the present invention relates to the process for the preparation of mixtures with an improved expandability based on vinylaromatic polymers.

In particular, a further object of the present invention relates to a process for preparing expandable compositions based on vinylaromatic polymers which comprises polymerizing in aqueous suspension a composition containing one or more vinylaromatic monomers, 0-50% by weight of a copolymer (a), obtained by polymerizing one or more vinylaromatic monomers and 0.1-15% by weight of α-alkylstyrene, and 0-10% by weight of a compatible polymer (b) with a crystallinity lower than 10% and a glass transition temperature (Tg) higher than 100° C., (a) and (b) being pre-dissolved in the monomeric mixture, in the presence of an expanding agent (c) added during or after the end of the polymerization, with the proviso that at least one of (a) or (b) is present in the reagent mixture.

At the end of the polymerization, substantially spherical polymer beads are obtained, with an average diameter ranging from 0.2 to 2 mm, inside which the expanding agent is homogeneously dispersed.

During the polymerization in suspension, polymerization additives, typically used for producing vinylaromatic polymers, are adopted, such as polymerization catalysts and chain transfer agents, through which it is also possible to regulate the molecular weight of the end-polymer, stabilizing agents of the suspension, expanding aids, nucleating agents, plasticizers, mineral fillers, etc. In particular, it is preferable to add, during the polymerization, mineral fillers of athermanous materials, such as graphite, or refracting agents, such as titanium dioxide, in quantities ranging from 0.05 to 25% by weight, calculated with respect to the resulting polymer.

The expanding agents are preferably added during the polymerization phase and are selected from aliphatic or cycloaliphatic hydrocarbons containing from 3 to 6 carbon atoms such as n-pentane, isopentane, cyclopentane or their mixtures; the halogenated derivatives of aliphatic hydrocarbons containing from 1 to 3 carbon atoms such as, for example, dichlorodifluoromethane, 1,2,2-trifluoroethane, 1,1,2-trifluoroethane; carbon dioxide and water.

To improve the stability of the suspension, it is possible to increase the viscosity of the reagent solution by dissolving some vinylaromatic polymer therein, in a concentration ranging from 1 to 30% by weight, preferably from 5 to 20%, calculated with respect to the polymer alone. The solution can be obtained either by dissolving a preformed polymer (for example fresh polymer or the waste products of previous polymerizations and/or expansions) in the reagent mixture or by pre-polymerizing the monomer, or mixture of monomers, in mass, in order to obtain the above concentrations, and then continuing the polymerization in aqueous suspension in the presence of the remaining additives, in particular (b) and (c).

Another object of the present invention relates to a process for preparing in continuous mass, expandable mixtures based on vinylaromatic polymers, which comprises the following steps in series:
i. feeding to an extruder a vinylaromatic polymer, together with 0-50% by weight of a copolymer (a), obtained by polymerizing one or more vinylaromatic monomers and 0.1-15% by weight of an α-alkylstyrene, and 0-10% by weight of a compatible polymer (b) with a crystallinity lower than 10% and a glass transition temperature (Tg) higher than 100° C., with the proviso that at least one of (a) or (b) is present in the mixture;
ii. heating the polymers to a temperature higher than the relative melting point;
iii. injecting the expanding agents into the molten product before extrusion through a die; and
iv. forming beads, optionally expandable, through a die, in a substantially spherical form with an average diameter ranging from 0.2 to 2 mm.

A detailed method for preparing expandable vinylaromatic polymers in continuous mass is provided in European patent EP 126,459.

At the end of the polymerization of the expandable vinylaromatic polymers, object of the present invention, the beads, either prepared in suspension or continuous mass process, are subjected to pre-treatment generally applied to traditional materials and which essentially consists in:
1. coating the beads with a liquid antistatic agent such as amines, tertiary ethoxylated alkylamines, ethylene oxide-propylene oxide copolymers, etc. The purpose of this agent is to facilitate both the adhesion of the coating and also the screening of the beads prepared in suspension;
2. applying the “coating” to the above beads, said “coating” essentially consists of a mixture of mono-, di- and trimesters of glycerin (or other alcohols) with fatty acids and of metallic stearates such as zinc and/or magnesium stearate.

Some illustrative but non-limiting examples are provided for a better understanding of the present invention and for its embodiment.

### EXAMPLE 1

98 parts of polystyrene granules having an MFI (measured at 200° C./5 kg) of 25 g/10′, a Mw of 130,000 and 2 parts of polyphenylene-ether (having a weight average molecular weight of 262,000), are fed into an extruder, through a hopper, and 500 ppm of polyethylene wax are added as nucleating agent.

6.5% of a mixture of n/i-pentane 80/20 is fed to the extruder, as expanding agent, through a specific injection line.

The polymer obtained containing the expanding agent is extruded through the holes of a die, cut by means of knives, baked at 60° C., dried and lubricated with 0.1% by weight of magnesium stearate and 0.3% by weight of glycerylmonostearate.

The beads are then expanded at various vaporization times and subsequently moulded into end-products. The expandability results are indicated in the following table.

### EXAMPLE 2

Example 1 is repeated, feeding 40 parts of styrene/α-methyl-styrene copolymer and 60 parts of the polystyrene used in Example 1.

6.2% of a mixture of n/i-pentane 80/20 is fed to the extruder as expanding agent. The copolymer contains 6.5% of α-methyl-styrene and has an Mw of 155,000. The expandability results are indicated in the following table.

### EXAMPLE 3 (Comparative)

Example 1 is repeated but using 98 parts of a polystyrene, having an MFI of 8 (Mw of 180,000), available on the market under the trade-name of Edistir N 1782 of ENICHEM S.p.A.

As can be seen from the table below, the product has only a very slight expansion, even if it does not collapse.

### EXAMPLE 4 (Comparative)

Example 1 is repeated but using only polystyrene granules (therefore 100 parts).

As can be seen from the table below, the product expands very much but collapses.

### EXAMPLE 5 (Comparative)

Example 4 is repeated but using only granules of polystyrene Edistir N 1782.

As can be seen from the table below, the product has only a very slight expansion, even if it does not collapse.

TABLE 1

| | Vapourization time | Density after |
|---|---|---|
| | (min.) | 24 hours (g/l) |
| EXAMPLE 1 | 1 | 16.5 |
| | 2 | 14 |
| | 3 | 12.5 |
| | 5 | 11 |
| | 7 | 10.9 |
| EXAMPLE 2 | 1 | 17 |
| | 2 | 13.8 |
| | 3 | 12.4 |
| | 5 | 11.1 |
| | 7 | 10.8 |
| EXAMPLE 3 | 2 | 19 |
| | 3 | 16.6 |
| | 5 | 14.8 |
| | 7 | 13.6 |
| | 10 | 12.7 |
| EXAMPLE 4 | 1 | 13 |
| | 2 | 12 |
| | 3 | 13 (*) |
| EXAMPLE 5 | 1 | 18 |
| | 2 | 15.6 |
| | 3 | 13.9 |
| | 5 | 12.7 |
| | 7 | 12.5 |

(*) Strong collapsing of the end-product

1-11. (canceled)

12. A process for the preparation of expandable compositions based on vinylaromatic polymers which comprises polymerizing in aqueous suspension a composition containing one or more vinylaromatic monomers, 0-50% by weight of a copolymer (a), obtained by polymerizing one or more vinylaromatic monomers and 0.1-15% by weight of α-alkylstyrene, and 0-10% by weight of a compatible polymer (b) with a crystallinity lower than 10% and a glass transition temperature (Tg) higher than 100° C., (a) and (b) being pre-dissolved in the monomeric mixture, in the presence of an expanding agent (c) added during or after the end of the polymerization, with the proviso that at least one of (a) or (b) is present in the reagent mixture.

13. A process for preparing in continuous mass, expandable vinylaromatic polymers which comprises the following steps in series:
i. feeding a vinylaromatic polymer to an extruder, together with 0-50% by weight of a copolymer (a), obtained by polymerizing one or more vinylaromatic monomers and 0.1-15% by weight of an α-alkylstyrene, and 0-10% by weight of a compatible polymer (b) with a crystallinity lower than 10% and a glass transition temperature (Tg) higher than 100° C., with the proviso that at least one of (a) or (b) is present in the mixture;
ii. heating the polymers to a temperature higher than the relative melting point;
iii. injecting the expanding agents into the molten product before extrusion through a die; and
iv. forming beads, optionally expandable, through a die, in a substantially spherical form with an average diameter ranging from 0.2 to 2 mm.

14. The process according to claim 12, wherein at the end of the polymerization, substantially spherical beads are obtained, with an average diameter ranging from 0.2 to 2 mm.

15. The process according to claim 12, wherein the expandable beads are subjected to a pretreatment consisting essentially of:
1. coating the beads with a liquid antistatic agent such as amines, tertiary ethoxylated alkylamines, ethylene oxide-propylene oxide copolymers;
2. applying the coating to said beads, said coating essentially consisting of a mixture of mono-, di- and tri-esters of glycerin with fatty acids and of metallic stearates such as zinc stearate.

16. (canceled)

17. Vinylaromatic polymers having an improved expandability which comprise:
d) a matrix obtained by polymerizing one or more vinylaromatic monomers and 0.1-14.5 by weight of an α-alkylstyrene;
e) 2-10% by weight, calculated with respect to the polymer (a), of an expanding agent englobed in the polymeric matrix;
f) 0-10% by weight, preferably 2-8%, calculated with respect to the polymer (a), of a compatible polymer with a crystallinity lower than 10% and a glass transition temperature (Tg) higher than 100° C.

18. Expandable heads of vinylaromatic polymers obtainable according to the process of claim 12 comprising 0.05-20% b. w. of athermaneous or refracting materials.

19. The process according to claim 13, wherein at the end of the polymerization, substantially spherical beads are obtained, with an average diameter ranging from 0.2 to 2 mm.

20. The process according to claim 13, wherein the expandable beads are subjected to a pretreatment consisting essentially of:
1. coating the beads with a liquid antistatic agent such as amines, tertiary ethoxylated alkylamines, ethylene oxide-propylene oxide copolymers;
2. applying the coating to said beads, said coating essentially consisting of a mixture of mono-, di- and tri-esters of glycerin with fatty acids and of metallic stearates such as zinc stearate.

21. The process according to claim 14, wherein the expandable beads are subjected to a pretreatment consisting essentially of:
1. coating the beads with a liquid antistatic agent such as amines, tertiary ethoxylated alkylamines, ethylene oxide-propylene oxide copolymers;
2. applying the coating to said beads, said coating essentially consisting of a mixture of mono-, di- and tri-esters of glycerin with fatty acids and of metallic stearates such as zinc stearate.

22. Expandable heads of vinylaromatic polymers obtainable according to the process of claim 13 comprising 0.05-20% b. w. of athermaneous or refracting materials.

23. Expandable heads of vinylaromatic polymers obtainable according to the process of claim 14 comprising 0.05-20% b. w. of athermaneous or refracting materials.
